(19) United States
(12) Patent Application Publication
(10) Pub. No.: US 2005/0237735 A1
(43) Pub. Date: Oct. 27, 2005

(54) Illuminating mount

(76) Inventor: Eagle Fan, Chu-Pei City (TW)

Correspondence Address: RABIN & Berdo, PC, 1101 14TH STREET, NW, SUITE 500, WASHINGTON, DC, 20005, US

(21) Appl. No.: 10/832,438

(22) Filed: Apr. 27, 2004

(51) Int. Cl. F21V 8/00

(52) U.S. Cl. 362/191

(57) ABSTRACT

An illuminating mount includes a housing having two clamps on top thereof with one of the clamps being movable relative to the housing and a transmission device received inside the housing to drive the one of the clamps to move. At least one light source is received inside the housing and a battery set is received inside the housing and electrically connected to the at least one light source. A switch is provided to control activation of the at least one light source.

### BACKGROUND OF THE INVENTION

1. Field of the Invention

The present invention relates to an illuminating mount, and more particularly to an illuminating mount for the operator to mount the illuminator on the roof of a vehicle so that the driver is able to warn other drivers that there is a malfunctioned vehicle and the driver's safety is thus guarded.

2. Description of Related Art

Almost every driver has experiences to have a car problem in a middle of nowhere at night. If the driver has the knowledge to repair the malfunction, the driver needs light so that he/she is able to check and see clearly about the malfunction. To the drivers who do not have the knowledge to repair the malfunction, a warning signal seems to be the best equipment to send the message out for help and to warn other drivers.

If the incident happens during the daytime, other drivers will have no problem spotting that there is a car problem on the roadside and the driver of the car either is trying to fix the problem or is walking around the car trying to attract others' attention. However, when the incident happens during the nighttime and there is no other lighting equipment around, drivers will have problem seeing the road clearly. Normally, the drivers drive their cars fast in the nighttime when passing the countryside. Therefore, without a proper lighting equipment, a driver with a car problem in a cloudy or rainy day is very likely to be hit by other drivers.

To overcome the shortcomings, the present invention intends to provide an improved illuminating mount to mitigate the aforementioned problems.

### SUMMARY OF THE INVENTION

The primary objective of the invention is to provide an illuminating mount having at least one light source to be used as an electrical light or a warning light.

Another objective of the invention is that a second light source is provided inside the illuminating mount such that the light of the second light source is able to transmit through the translucent housing of the illuminating mount to send out warning signals.

In order to accomplish the foregoing objectives, two clamps are provided on top of a housing and one of the clamps is movable and operateably connected to a transmission device. With the activation of the switch mounted on the housing, the at least one light source can be used as an electrical light or a warning light. Furthermore, the two clamps can be used to hold therebetween a mobile phone or the like.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of the present invention;

FIG. 2 is a top plan view of the first embodiment of the present invention;

FIG. 3 is a cross-sectional view of the first embodiment of the present invention;

FIG. 4 is a perspective view of a second preferred embodiment of the present invention;

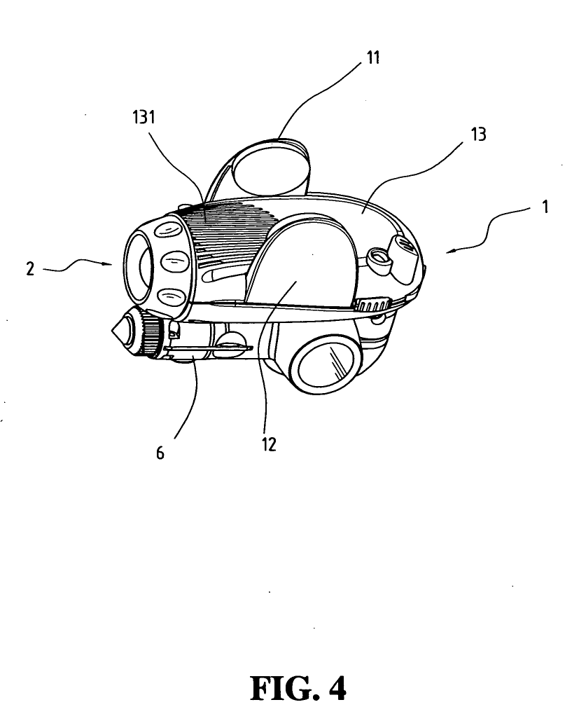

FIG. 5 is a partial cross-sectional view of the second preferred embodiment of the present invention;

FIG. 6 is a perspective view showing a baffle plate of the second preferred embodiment of the present invention;

FIGS. 7A and 7B are schematic views showing the application of the second preferred embodiment of the present invention;

FIG. 8 is a schematic view showing a third preferred embodiment of the present invention;

FIG. 9 is a perspective view showing an auxiliary clamping plate of the third embodiment of the present invention;

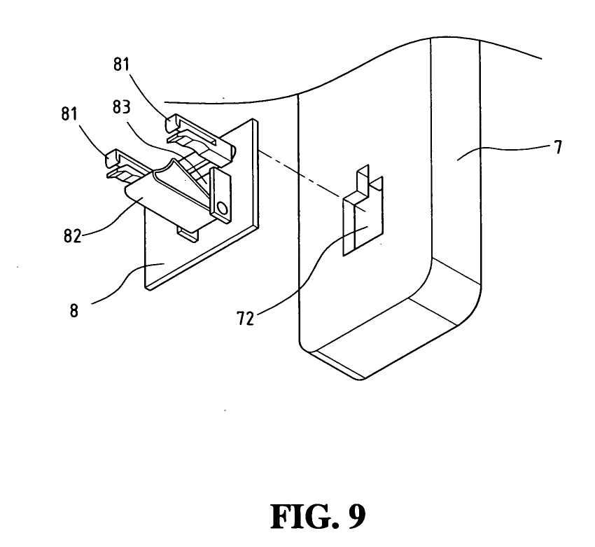

FIG. 10 is a top plan view of a fourth preferred embodiment of the present invention;

FIG. 11 is a partial cross-sectional view of the fourth preferred embodiment of the present invention; and

FIG. 12 is a schematic view showing the application of the fourth preferred embodiment of the present invention.

### DETAILED DESCRIPTION OF PREFERRED EMBODIMENTS

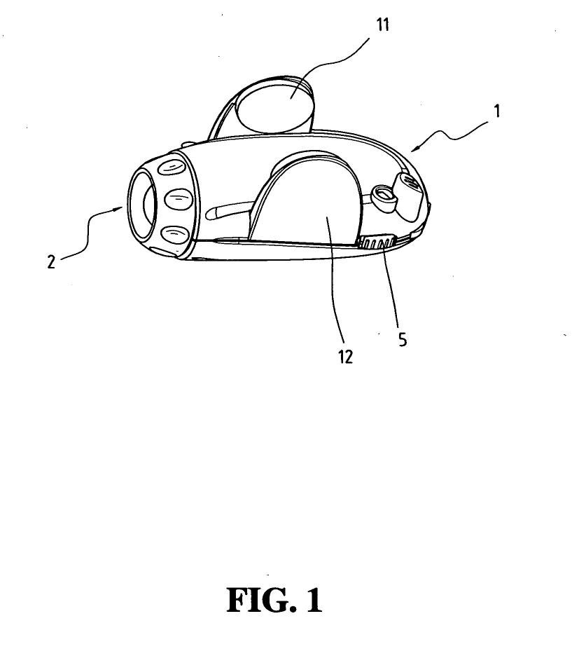

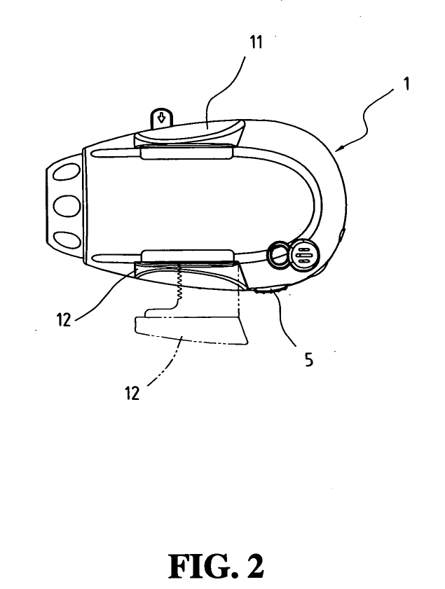

With reference to FIGS. 1, 2 and 3, an illuminating mount in accordance with the present invention includes a housing 1 with two clamps 11, 12 mounted on top of the housing 1 to clamp therebetween a mobile phone or a personal digital assistance (PDA), wherein one of the two clamps 11, 12 is movable relative to the housing 1, as shown in the dashed lines in FIG. 2. The movable clamp 11, 12 is connected to a transmission device to move the movable clamp 11 or 12 and the transmission device is conventional in the art such that the detailed description thereof is omitted for brevity.

The housing 1 has at least one light source 2 using the control of a circuit board 10 to function as an electrical light or a warning light. The housing 1 has a battery set 4 and a switch 5 electrically connected to the at least one light source 2 such that the user is able to use the switch 5 to control the activation of the at least one light source 2.

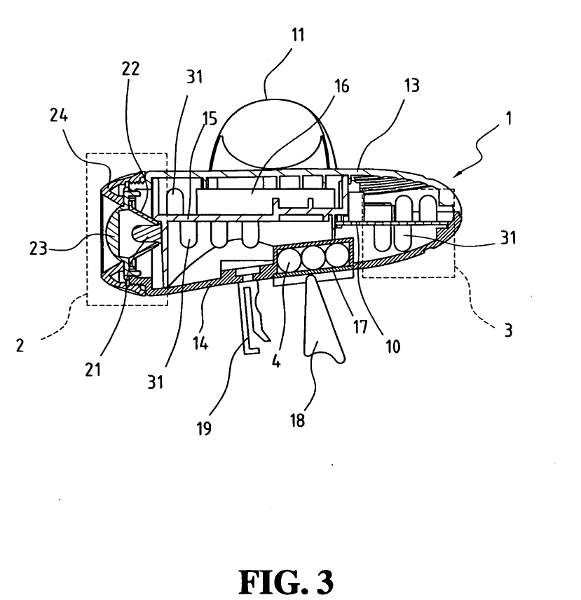

Preferably, two light sources 2, 3 are provided inside the housing 1. The second light source 3 is mounted inside the housing 1 such that the second light source 3 is able to penetrate through the translucent material that is used to make the housing 1 to create an effective warning signal. With reference to FIG. 3, the housing 1 is composed of a top cover 13 and a bottom cover 14 interconnected to the top cover 13 to define a hollow space inside the housing 1. A baffle plate 15 is provided inside the housing 1 to divide the light source 2, the second light source 3, the circuit board 10, and the transmission device 16 (shown in dashed box). The battery set 4 is provided on the bottom cover 14 and has a battery cap 17 to allow the user to have access to the battery. A block 18 is pivotally connected to a bottom of the battery cap 17 and a clipper 19 is detachably mounted on the bottom cover 14. When the clipper 19 is applied to the vehicle front panel, the clipper 19 is able to be secured to the blades of the wind outlet and the stop 18 is able to abut against a side wall of the front panel to adjust the housing 1 to a suitable angle when the illuminating mount of the present invention is used to hold a mobile phone. When the illuminating mount is to be used as an electrical light, the user only needs to disassemble the clipper 19 from the housing 1.

The light source 2 is provided on one side of the housing 1 and includes a light emitting diode 21 (LED) which is mounted on a side of the baffle plate 15, a reflecting cone 22 enclosing the LED 21, a transparent lens 23 mounted at one end of the housing 1 to be in front of the LED 21 and an outer cap 24 threadingly connected to the top cover 13 and the bottom cover 14. Furthermore, wires are provided to electrically connect the LED 21 to the circuit board 10. Thus the user is able to use the switch to light the LED 21. If a warning light is required, the user is able to use the circuit of the circuit board 10 to flash the LED 21. Therefore, when there is a vehicle malfunction, the user is able to mount the illuminating mount on top of the vehicle roof to send out warning signals.

The second light source 3 is mounted on the circuit board 10 and the baffle plate 15 and is composed of multiple LEDs 31, which are controlled by the circuit board 10. The top cover 13 and the bottom cover 14 are made of transparent material or of colored material and ribs are formed respectively on side faces of the top cover 13 and the bottom cover 14 to guide the light of the second light source 3 to emit outward. In the preferred embodiment of the present invention, the main function of the second light source 3 is to emit light. Therefore, with the predetermined lighting pattern in the circuit board 10, the second light source 3 is able to emit a required light or the multiple LEDs 31 are able to intermittently flash to increase the lighting diversity. The user is then able to use the switch 5 to control the activation of the lighting of the second light source.

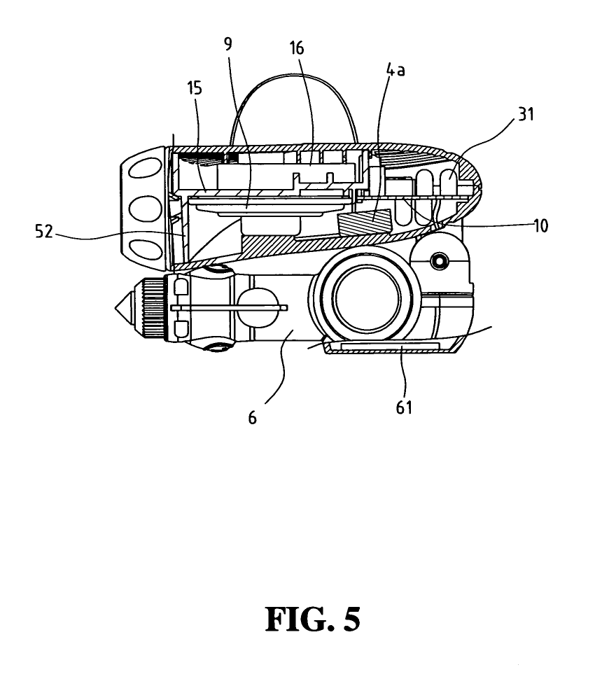

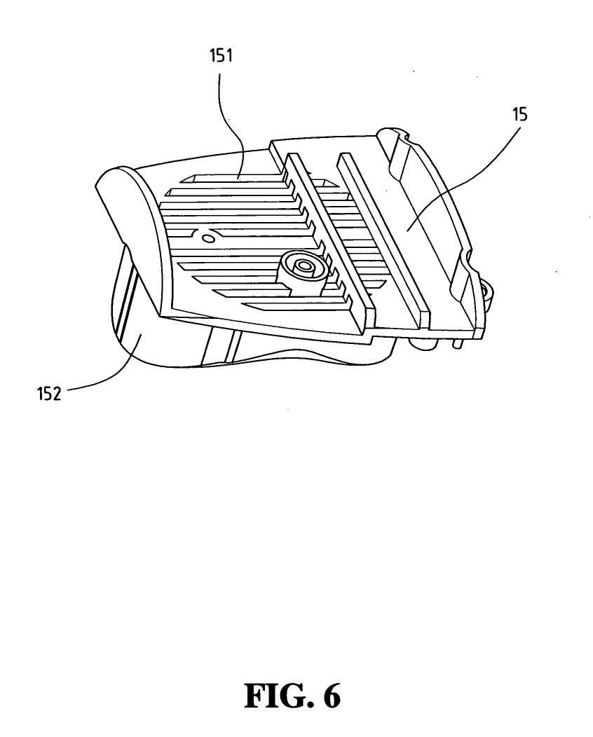

With reference to FIGS. 5 and 6, which is a second preferred embodiment of the present invention, the housing 1 and an onboard cigarette lighter 6 are combined to make the illuminating mount a mobile phone holder, wherein the baffle plate 15 has multiple slits 151, as shown in FIG. 6. A casing 152 is formed under the slits 151 to enclose a speaker 9. Corresponding to the slits 151, the top cover 13 has multiple second slits 131 to allow the sound from the speaker 9 to be sent out from the second slits 131. In this embodiment, the battery set 4a uses rechargeable batteries. The power source for the batteries in this embodiment is the cigarette lighter 6. In order to drive the speaker 9 and to recharge the batteries from the cigarette lighter 6, the circuit board 10 is equipped with charging circuit and circuit to drive the speaker 9. Furthermore, a magnet 61 is mounted on a bottom of the cigarette lighter 6.

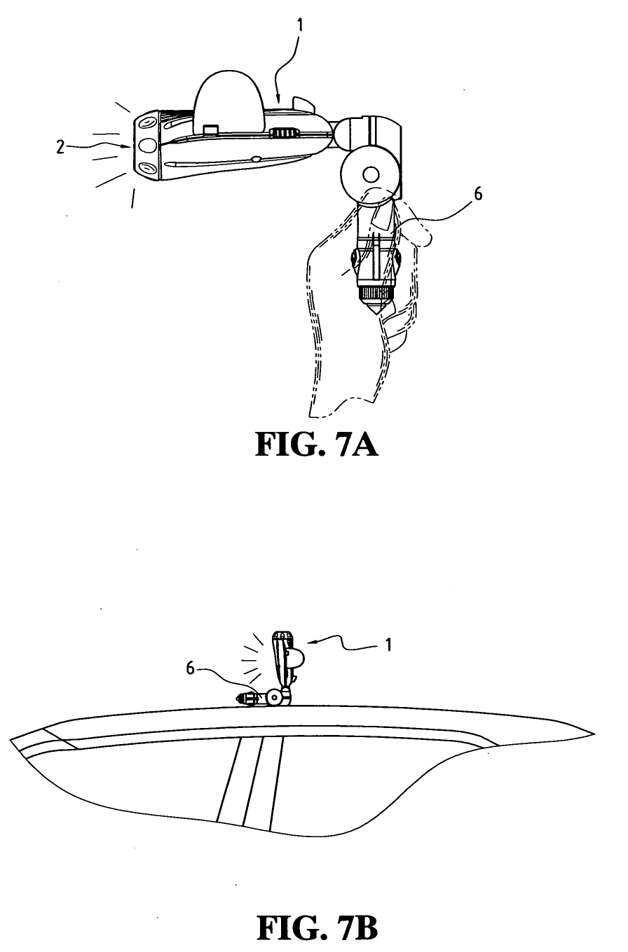

When the invention is in application, the cigarette lighter 6 is inserted into the cigarette lighter socket to secure the position of the cigarette lighter 6. The mobile phone is then clamped between the two clamps 11, 12. The user is able to use the switch 5 to activate the second light source 3 to illuminate the mobile phone and the illuminating mount of the present invention to enable the user to have easy access to the mobile phone. With reference to FIG. 7A, the user may hold the cigarette lighter 6 as a holder and use the light source 2 as a light source to make the illuminating mount of the present invention as an electrical light. Further, the magnet 61 on the bottom of the cigarette lighter 6 is able to place the illuminating mount securely on the vehicle roof or hood such that either the user is proceeding the maintenance of the vehicle or asking for help, the illuminating mount of the present invention is able to effectively achieve the desired goals.

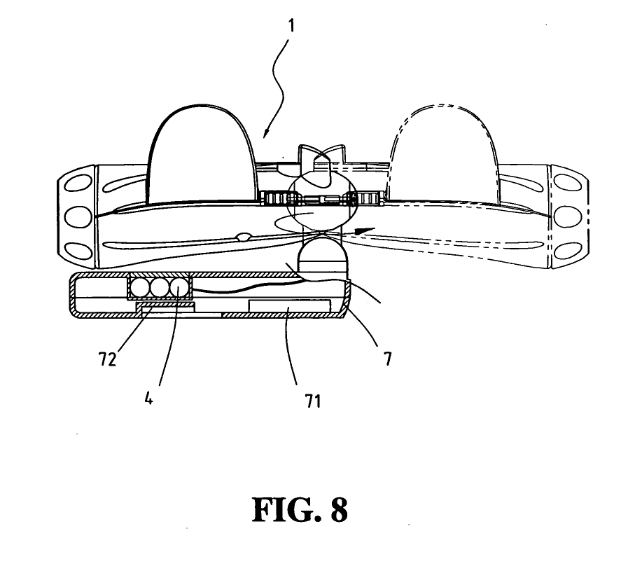

With reference to FIG. 8, a joint 7 is pivotally connected to the bottom of the housing 1, wherein the batteries are provided inside the joint 7 instead of the housing 1 and has a flat bottom with a magnet 71 securely received inside the flat bottom of the joint 7. The pivotal connection between the joint 7 and the housing 1 is able to accomplished by any appropriate method to allow the joint 7 to pivot 360 degrees relative to the housing 1, as shown in dashed lines in FIG. 8. If the embodiment is to be used inside a vehicle, an auxiliary clamp 8 is required and composed of multiple clamping plates 81 and a stopping plate 82 extending between the clamping plates 81. A block 83 is provided on a rear side of the auxiliary clamp 8 and has a configuration to be fitted into a hole 72 inside the joint 7 to allow the clamping plates 81 to fix the position of the illuminating mount of the present invention inside the vehicle.

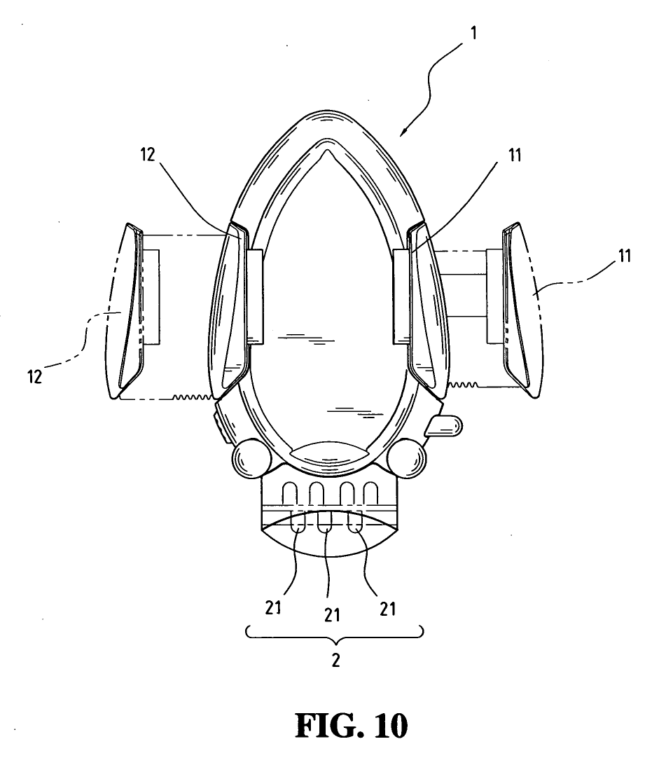

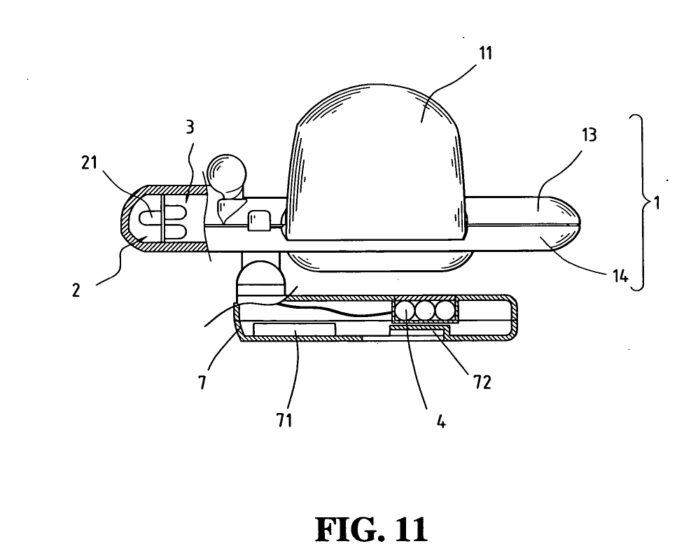

With reference to FIGS. 10 and 11, which show a fourth embodiment of the present invention, the clamps 11 12 can move simultaneously to different directions to increase distance therebetween, as shown in dashed lines. Thus beside the mobile phone, a personal digital assistance or a global positioning system can be clamped by the two clamps 11, 12.

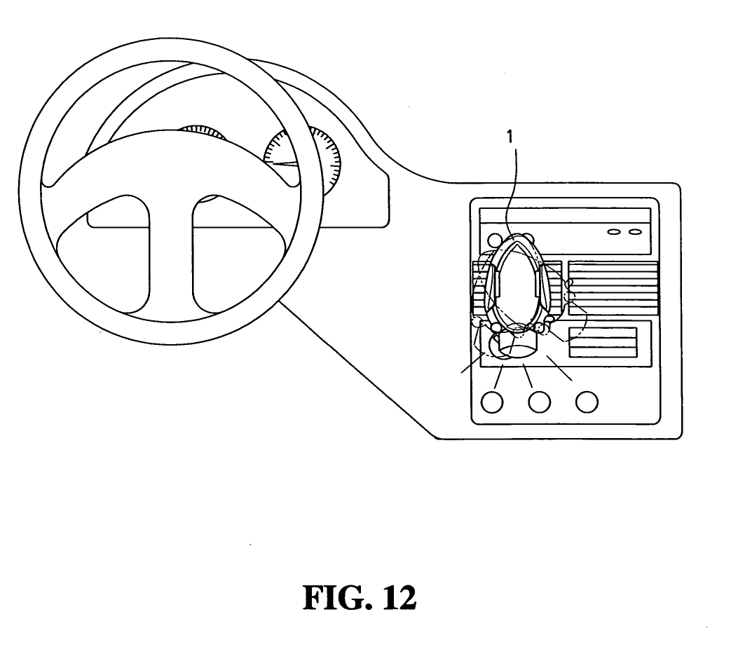

With reference to FIG. 12, when the illuminating mount is installed inside the vehicle, the auxiliary clamp 8 is able to secure the illuminating mount on the air duct grill inside the vehicle. Therefore, the user is able to use the illuminating mount as a reading light for reading or checking a map.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An illuminating mount comprising:
a housing having two clamps on top thereof with one of the clamps being movable relative to the housing and a transmission device received inside the housing to drive the one of the clamps to move;
at least one light source received inside the housing;
a battery set received inside the housing and electrically connected to the at least one light source; and
a switch controlling activation of the at least one light source.

2. The illuminating mount as claimed in claim 1, wherein two light sources, a first light source and a second light source, are provided inside the housing and opposite to each other.

3. The illuminating mount as claimed in claim 1, wherein the first light source is composed of multiple light emitting diodes, a reflecting cone enclosing the light emitting diodes, a transparent lens mounted at one end of the housing to be in front of the light emitting diodes and an outer cap threadingly connected to the housing.

4. The illuminating mount as claimed in claim 3, wherein a circuit board is provided inside the housing to control the activation of the light emitting diodes.

5. The illuminating mount as claimed in claim 1, wherein the housing is made of a transparent material so that light from the light emitting diodes is able to penetrate the housing to show vivid lighting effect.

6. The illuminating mount as claimed in claim 1, wherein the housing is made of a colored material so that light from the light emitting diodes is able to penetrate the housing to show vivid colorful lighting effect.

7. The illuminating mount as claimed in claim 1, wherein the battery set is composed of rechargeable batteries.

8. The illuminating mount as claimed in claim 1, wherein the housing is composed of a top cover and a bottom cover, the top cover has slits defined through a top face thereof and a baffle plate is provided inside the housing and has multiple second slits to send out sound from a speaker mounted under the baffle plate.

9. The illuminating mount as claimed in claim 1, wherein an onboard cigarette lighter is pivotally connected to the housing.

10. The illuminating mount as claimed in claim 9, wherein the onboard cigarette lighter has a flat side with a magnet received inside the flat side.

11. An illuminating mount comprising:
a housing having two clamps on top thereof with one of the clamps being movable relative to the housing, a transmission device received inside the housing to drive the one of the clamps to move and a joint pivotally connected to a bottom of the housing;
at least one light source received inside the housing;
a battery set received inside the housing and electrically connected to the at least one light source; and
a switch controlling activation of the at least one light source.

12. The illuminating mount as claimed in claim 11, wherein two light sources, a first light source and a second light source, are provided inside the housing and opposite to each other.

13. The illuminating mount as claimed in claim 11, wherein a circuit board is provided inside the housing to control the activation of the light emitting diodes, and the housing is made of a transparent material so that light from the light emitting diodes is able to penetrate the housing to show vivid lighting effect.

14. The illuminating mount as claimed in claim 11, wherein the joint has a flat side with a magnet received inside the flat side.

15. The illuminating mount as claimed in claim 11, wherein the at least one source is composed of multiple light emitting diodes.
